(19) United States
(12) Patent Application Publication
(10) Pub. No.: US 2024/0070788 A1
(43) Pub. Date: Feb. 29, 2024

(54) ACCESS CONTROL METHOD

(71) Applicant: Carrier Corporation, Palm Beach Gardens, FL (US)

(72) Inventor: Hrishi Eathakota, Hyderabad, Telangana (IN)

(21) Appl. No.: 17/768,377

(22) PCT Filed: Sep. 29, 2020
(86) PCT No.: PCT/IB2020/059075

§ 371 Date: Apr. 12, 2022

(30) Foreign Application Priority Data
Oct. 18, 2019 (IN) 201911042413

(51) Int. Cl. G06Q 50/00; G06F 21/31

(52) U.S. Cl. CPC G06Q 50/01; G06F 21/31

(57) ABSTRACT

Aspects of the invention are directed towards method, system and devices assisting a user in providing seamless access to a user through accessing devices of any premises related to any event. A user terminal is configured to receive one or more alerts related to an event on a social media platform. The event is subscribed by the user. On successful subscription, the user is configured to receive access credentials related to an event on the user terminal which may be further linked with the social media account of the user.

### TECHNICAL FIELD OF INVENTION

The present invention relates generally to security systems. More particularly, the invention relates to an apparatus and method for providing seamless access to the user through an access control system using social media platforms.

### BACKGROUND OF THE INVENTION

Social media platforms such as Facebook®, LinkedIn®, Twitter®, or Instagram® enable users to create content, share content, and let users participate in a social network. The use of the social media platforms has enhanced social networking in short period of time. At the same time, the social media platforms have become power house of advertisement campaigns. For example, a user may advertise any product or any event quickly by posting the relevant content on the Social media Platform with a wide range of audience. Also, the user is able to assess the success of the product or the event by making the advertisement interactive.

An advertisement is made interactive by enabling viewers of the advertisement to interact with the content by following, subscribing, or purchasing the advertisement/event depending on the type of advertisement.

Social media platforms can be very useful for the hospitality industry in promoting large conventions or market freebies or events or special offers at different points in time. For example, if a hotel wants to give a free lunch to 50 Hotel Guests who are in a lobby, they could market this via social media platforms and the first predefined subscribers who respond to event notification on the social media platforms could be given access to the restaurant, lounge, pool parties and the like.

Moreover, when dealing with seamless digital credentials and access, in order to have the best experience, users need to have access to premises of the event organized by the hotels and the like in seamless way.

Therefore, there is a need in the art to develop methods and systems for providing mechanisms to seamlessly access the access control systems through the social media platforms. There is also need in the art to avoid hassles in organizing events such as promotional events and providing access thereof.

### SUMMARY OF THE INVENTION

Various embodiments of the invention describe a method for providing seamless access to a user through an access-controlled system during events using social media platform. The method describes receiving one or more alerts related to an event on the social media platform from a service provider. The method further describes subscribing to the event on the social media platform. The response of the subscription is sent to the service provider. Based on the receipt of the response by the service provider, access credentials for the event are received on a user application associated with a user.

In another embodiment of the invention, on receipt of a response of the subscription by the service provider, the subscription is evaluated by the service provider.

In yet another embodiment of the invention, the service provider evaluates the subscriptions from a plurality of users and the evaluation determines one or more users for providing the access credentials.

In an embodiment of the invention, the service provider connects with a server to provide the access credentials of the premises to the user.

In yet another embodiment of the invention, the user is registered with the social media platform before receiving the one or more alerts. The registered user is associated with an account on the social media platform.

In another embodiment of the invention, the account of the user on the social media platform is linked with the access credentials received by the user.

In still another embodiment of the invention, the user accesses the event using the received access credentials.

In yet another embodiment of the invention, the access credentials received are valid for a predetermined time interval.

In another embodiment of the invention, the access credentials are received by a predefined number of users.

In still another embodiment of the invention, the access credentials are received by the users based in order in which the response to the advertisement is given by the users.

In another embodiment of the invention, the user receiving the access credential shares details related to the event and multimedia content related to the event with other users.

Various embodiments of the invention describe a user terminal configured for providing seamless access to a user of a user terminal to an event. The user terminal comprises a first receiving unit adapted to receive one or more alerts related to an event on a social media platform from a service provider. A subscription unit is adapted to subscribe to the event on the social media platform. The user terminal further comprises a transmitting unit adapted to send a response of the subscription to the service provider. There is a second receiving unit adapted to receive access credentials for premises of the event on a user application associated with the user based on the response.

In an embodiment of the invention, on receipt of a response of the subscription by the service provider, the subscription is evaluated by the service provider.

In another embodiment of the invention, the service provider evaluates the subscriptions from a plurality of users and the evaluation determines one or more users for providing the access credentials.

In yet another embodiment of the invention, the service provider connects with a server to provide the access credentials of the event to the user.

In another embodiment of the invention, the user is registered with the social media platform before receiving the one or more alerts, wherein the registered user is associated with an account on the social media platform.

In still another embodiment of the invention, the account of the user on the social media platform is linked with the access credentials received by the user.

In another embodiment of the invention, the one or more alerts correspond to advertisements related to the event, wherein the advertisements are promotional events.

In another embodiment of the invention, the access credentials are received by a predefined number of users.

In various other embodiments of the invention a computer readable medium is disclosed comprising one or more processors and a memory coupled to the one or more processors. The memory stores instructions which are executed by the one or more processors to receive one or more alerts related to an event on the social media platform from a service provider. The event is subscribed on the social media platform. The one or more processors are configured to send a response of the subscription to the service provider and configured to receive access credentials for premises on a user application associated with the user based on the response.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is an exemplary diagram illustrating a system in accordance with an embodiment of the invention.

FIG. 2 is an exemplary screen on a user terminal depicting a method in accordance with an embodiment of the invention.

FIG. 3 is an exemplary block diagram depicting different components on a user terminal to enable the invention in accordance with an embodiment of the invention.

FIG. 4 is an exemplary flowchart illustrating different steps to enable the invention in accordance with an embodiment of the invention.

Corresponding reference numerals indicate corresponding parts throughout the drawings.

### DETAILED DESCRIPTION OF THE INVENTION

Described herein is the technology with systems, methods, and devices for seamless access to a user in a premises with access control systems such as hotels, offices, concerts, carnivals and the like using the social media platforms. In different embodiments of the invention by using the social media platforms the organizers of any event may advertise the event with any suitable description. For example, the event may be advertised by using hash tags for e.g. #PromoEvent. The advertised event may be received by a number of users associated with the social media platform. The users receive the advertised event on an account associated with the social media platform. The users to whom the advertisement/notification of the event is sent may be selected by the organizer of the event. In an embodiment of the invention, the organizer of the event may be a service provider. In another embodiment of the invention, the organizer of the event may be associated with a hospitality industry, for example. The examples of the service provider described herein are not limited and the invention may be applied to different fields and are within the scope of the invention.

In an embodiment of the invention, the social media platform may correspond to a Facebook®, LinkedIn®, Twitter®, or Instagram® platform. The service provider may be associated with an account on the social media platform. Similarly, users may be associated with their respective accounts. The users with the accounts may be termed as “registered users” on the social media platform. The social media platform may be used by the service provider for sending the alerts and notifications related to advertisement and the users receive such alerts and notifications. The account may be created and operated by the service provider. Similarly, the users may create social media account on the social media platform. The social media accounts are operated using user credentials known to a person skilled in the art.

The users receiving the event alert or notification may subscribe to the event. In an embodiment of the invention, the users may receive the notification provided by the service provider on their respective social media accounts associated with the social media platform. The users may be provided with options such as subscribe, unsubscribe, like, dislike, or other options known to skilled in the art. If any user subscribes to the event, a response of subscription is sent to the service provider. It may be noted that the social media platform may be operated on a server. Moreover, sending and receiving the notifications and alerts between the service provider and the users is facilitated by the server. On receipt of the subscription from the users, the organizer or the service provider may select the users for providing access to the event. The selection of the users for providing the access may be based on an evaluation by the service provider. The evaluation may be general evaluation process or as per the requirement of the service provider. The evaluation may be any process which is known to a person skilled in the art and may be used to selects one or more users from a plurality of users who have subscribed to the event.

In an embodiment of the invention, the access to the event may be determined based on a first subscription basis. The subscribed users may be preferred based on a number of parameters. The subscribed users may be preferred in the order of subscription to the event notification. In an embodiment of the invention, a subscribed user who is a VIP user may be preferred over other users. In another example, a subscribed user who is a frequent visitor to the service provider may be preferred. In yet another embodiment a subscribed user who is a business traveler may be preferred. The type of users described herein are exemplary and the preference may be made based on the parameters known to a person skilled in the art.

The selection of the subscribers by the service provider may be limited to predefined number of users. The selected subscribers or users may be provided with access credentials for the event. In an embodiment of the invention, the event may be organized in a premises with one or more accessing devices. The one or more accessing devices may be accessed using the credentials received from the service provider by the users. The user credentials are linked with the social media account (profile) of the user. The user credentials may be provided to the users in the order of the subscription to the event. In other words, a user subscribing to the event first may receive the access credentials before other users subscribing to the event. Further, the user may attend the event by using the social media profile and access credentials. The user may further share details related to the event and any multimedia content such as the video and audio content related to the event. The video content may be the video shared by the service provider, for example. The audio content may be any speech or audio recording available related to the event.

Various embodiments of the invention describe a method for seamless access of the event or the premises during an event such as a promotional event. The method describes receiving one or more alerts or notifications from a service provider. The one or more alerts are received by a user on a social media platform. The user may subscribe to the event on the social media platform. The service provider and the user may use a common social media platform with their respective accounts. After subscribing to the event, a response of the subscription is sent to a service provider. The service provider may further select the predefined number of users. The selected users may be provided with access credentials by the service providers. The access credentials are received by each user. On receipt of the access credentials from the service provider, the access credentials are linked to the social media account of the user.

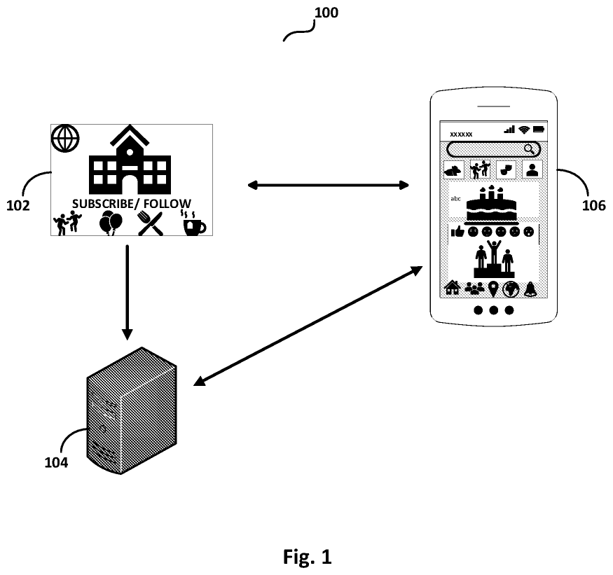

Turning now to figures, FIG. 1 depicts a system 100 for seamless access of secured premises to a user with the help of a user terminal 106. The user terminal 106 includes a wireless communication unit (not shown) such as a Bluetooth module according to an embodiment of the invention. The system includes a display terminal 102 associated with a service provider. The service provider may use a social media platform to initiate a promotional event campaign using the social media platform from the display terminal 102. The social media platform operates from a server 104 as known to a person skilled in the art. The promotional event may be transmitted to the users which are determined by the service provider. The determination of users may be based on a number of parameters such as VIP user, frequent user, business traveler and the like depending on the requirement of the service provider. Each of the selected users may have a user terminal 106 to receive the promotional event. In an embodiment of the invention the users receive the promotional event from the service provider on the social media platform. In an embodiment of the invention, the promotional event is received on the same social media platform associated with both the service provider and the user.

The user terminal 106 on receipt of the promotional event may subscribe to the promotional event by pressing a button available along with the alert or notification of the promotional event. On subscription of the promotional event, the user terminal may send a response of subscription to the service provider. The response may be directed to the service provider via the server 104. Alternatively, the response may be sent directly to the service provider and may be viewed by the service provider on the display terminal 102. Based on the response received by the service provider, access credentials for the promotional event may be issued to the user. The access credentials may be provided to the user through a user application on the user terminal 106. In an embodiment of the invention, the user application may be associated with the service provider. The account of the user on the social media platform is then linked with the user credentials received by the user application.

The user terminal 106 may be any hand held device such as a smartphone or a tablet and the like with at least a display, a storage unit and a wireless connectivity, for example, a Bluetooth, as discussed above. As an example, the hand held device may be an Apple® tablet or smartphone, an Android® tablet or smartphone, a Windows® tablet or smartphone and/or the like. According to an embodiment of the invention, the user terminal 106 communicates with the server 104 or directly with the display terminal 102. The user terminal 106 may be configured to automatically transmit user credentials to gain access in to the secured premises of the promotional event. In general, an operating system is available on the user terminal 106 that provides an interface for the user to communicate with the access system. In an example, the operating system installed on the hand held device or the user terminal is an Android® based operating system, a Window® based operating system, and an Apple® based operating system or any other operating system known in the art.

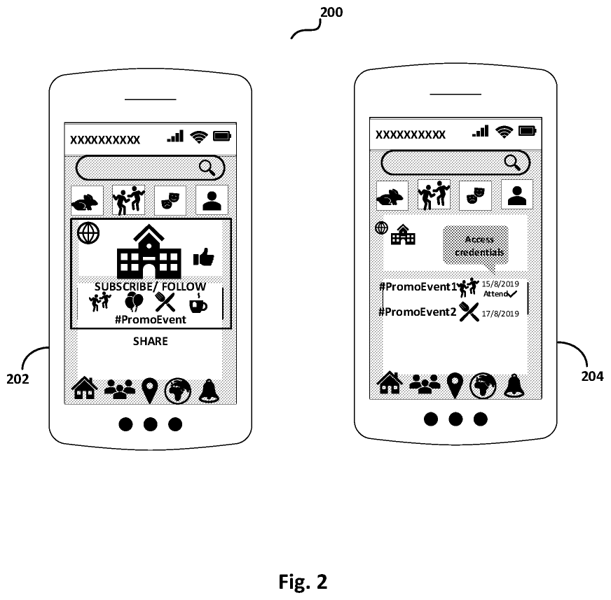

FIG. 2 depicts a display screen on a user terminal 202 where a social media account of the user is displayed. The user terminal 202 receives a notification of an event. The screen further displays an option to the user for subscribing to the event. The subscription can be made my tapping a button on the display screen. Various other input means such as voice command, pressing a button and the like are within the scope of the invention. On subscription of the event, the response of subscription is sent to the server 104 which may be further received by display terminal 102 of the organizer or the service provider. The response may be sent directly to the service provider on the display terminal 102. Subsequently, the service provider selects the users from the subscribed users for sending the access credentials as discussed above.

The display screen 204 of the user terminal displays a user application where the access credentials sent from the service provider are received by the user. The user application is configured to store the access credentials and link the access credentials with the social media account of the user. The user application may also be configured to record the date and time of the event and may prompt the user regarding the event within a predefined time before the event.

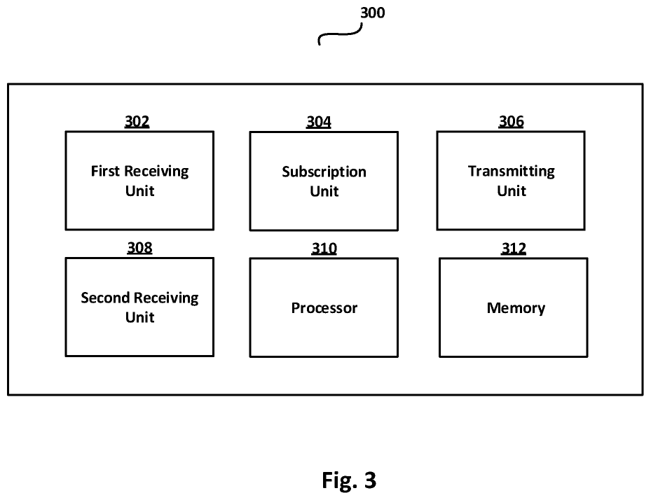

FIG. 3 depicts a user terminal 300 comprising a first receiving unit 302, a subscription unit 304, a transmitting unit 306, a second receiving unit 308, a processor 310, and a memory 312. There may be other units associated with the user terminal 300 to enable the invention. The first receiving unit is adapted to receive one or more alerts related to an event on a social media platform. The first receiving unit receives the one or more alerts on a user account associated with the social media platform. A subscription unit 304 of the user terminal 300 is adapted to input the subscription provided by a user of the user terminal 300. The response of the subscription is transmitted to the server 104 using a transmitting unit 306. Based on the response of subscription, the service provider may use the display terminal 102 to select the users for providing access credentials for accessing the premises associated with the event. The selection of the users is discussed above. The service provider may send the access credentials to the user. A second receiving unit 308 of the user terminal 300 is adapted to receive the access credentials from the service provider. The user terminal 300 receives the access credentials on a user application associated with the user. The user application is further configured to link the access credentials with the social media account of the user.

The first receiving unit 302, the subscription unit 304, the transmitting unit 306, the second receiving unit 308 may be communicably coupled with the processor 310. It is to be noted that all the units described herein are exemplary and the embodiments of the invention may be achieved by using a single unit having all the features of the units mentioned herein.

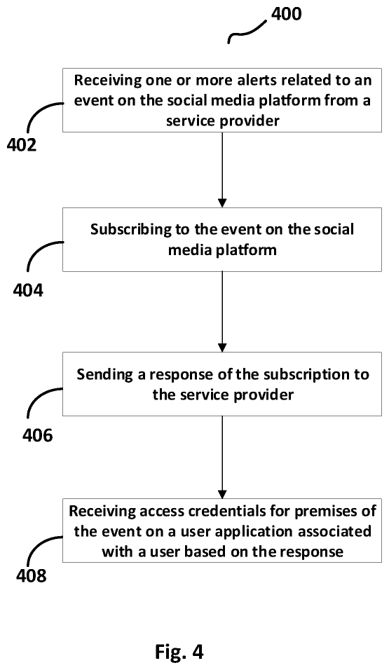

FIG. 4 depicts a flowchart outlining the features of the invention in an embodiment of the invention. The flowchart 400 describes a method being performed for enabling the invention. The method starts at 402 by receiving one or more alerts or notifications related to an event on a social media platform from a service provider. The service provider uses his social media account to send the one or more alerts to the users which are received by a social media account of the user associated with the social media platform. At step, 404, the user subscribes to the event on the social media platform. The response of the subscription is sent to the service provider through the social media platform, 406. As discussed above, the service provider selects the users for providing the access credentials. The access credentials are received by the user at step 408. The access credentials may be used to access premises associated with the event. Further, the access credentials are received on a user application of the user. The user application may further link the received user credentials with the social media account of the user.

Another embodiment of the invention discloses a computer readable medium comprising one or more processors and a memory coupled to the one or more processors, the memory storing instructions which are executed by the one or more processors, the one or more processors are operable to receive one or more alerts related to an event on the social media platform from a service provider. The one or more alerts are received on an account of a user on a social media platform. The one or more processors are configured to receive an input from a user to subscribe to the event. Based on the subscription, one or more processors are configured to send a response of the subscription to the service provider. The service provider may select the users for providing access credentials for accessing premises of the event. The access credentials are received by one or more processors. The access credentials are stored on a user application. Further, the access credentials are linked with the social media account of the user.

The various embodiments of the invention described herein can be combined and performed to enable the invention and is within the scope of the invention.

The invention provides various advantages by enabling advertisements of events on a social media platform and seamlessly linking it with the access systems such as entrances, doors etc. The invention provides a frictionless and adaptable approach to access the security system from a user application by using the social media profile.

Exemplary computer readable media includes flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this invention are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the invention are capable of implementation with numerous other general purpose or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures and described herein. Other examples of the invention may include different computer-executable instructions or components having more or less functionality than illustrated and described herein.

Aspects of the invention transform a general-purpose computer into a special-purpose computing device when configured to execute the instructions described herein.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “data store,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The embodiments of the invention discussed herein are exemplary and various modification and alterations to a person skilled in the art are within the scope of the invention.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

Further reference to any content has been made throughout the specification and words and phrases such as “user device”, “user terminal”, “mobile terminal”, “mobile phone”, or the like have been interchangeably used and means the handheld device for installing the configuration for all the devices in the system. Moreover, the words and phrases like “cloud”, “server”, “cloud server” and “database” or the like have been interchangeably used which means a storage location located remotely for storing configuration and configuration updates for all the devices in the system. Further words and phrases like, “service provider”, “organizer” or the like have been interchangeably used which means a service provider providing advertisements and access credentials to the users.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

We claim:

1. A method comprising:
receiving one or more alerts related to an event on the social media platform from a service provider;
subscribing to the event on the social media platform;
sending a response of the subscription to the service provider; and
receiving access credentials for the event on a user application associated with a user based on the response.

2. The method of claim 1, wherein on receipt of a response of the subscription by the service provider, the subscription is evaluated by the service provider.

3. The method of claim 2, wherein the service provider evaluates the subscriptions from a plurality of users, wherein the evaluation determines one or more users for providing the access credentials.

4. The method of claim 1, wherein the service provider connects with a server to provide the access credentials of the premises to the user.

5. The method of claim 1, wherein the user is registered with the social media platform before receiving the one or more alerts, wherein the registered user is associated with an account on the social media platform.

6. The method of claim 5, wherein the account of the user on the social media platform is linked with the access credentials received by the user.

7. The method of claim 1, wherein the user accesses the event using the received access credentials.

8. The method of claim 1, wherein the access credentials received are valid for a predetermined time interval.

9. The method of claim 1, wherein the access credentials are received by a predefined number of users.

10. The method of claim 10, wherein the access credentials are received by the users based in an order in which the response to the advertisement is given by the users.

11. The method of claim 10, wherein the user receiving the access credential shares details related to the event and multimedia content related to the event with other users.

12. A user terminal comprising:
a first receiving unit adapted to receive one or more alerts related to an event on a social media platform from a service provider;
a subscription unit adapted to subscribe to the event on the social media platform;
a transmitting unit adapted to send a response of the subscription to the service provider; and
a second receiving unit adapted to receive access credentials for premises of the event on a user application associated with the user based on the response.

13. The user terminal of claim 12, wherein on receipt of a response of the subscription by the service provider, the subscription is evaluated by the service provider.

14. The user terminal of claim 13, wherein the service provider evaluates the subscriptions from a plurality of users, wherein the evaluation determines one or more users for providing the access credentials.

15. The user terminal of claim 12, wherein the service provider connects with a server to provide the access credentials of the premises to the user.

16. The user terminal of claim 12, wherein the user is registered with the social media platform before receiving the one or more alerts, wherein the registered user is associated with an account on the social media platform.

17. The user terminal of claim 16, wherein the account of the user on the social media platform is linked with the access credentials received by the user.

18. The user terminal of claim 12, wherein the one or more alerts correspond to advertisements related to the event, wherein the advertisements are promotional events.

19. The user terminal of claim 12, wherein the access credentials are received by a predefined number of users.

20. A computer readable medium comprising one or more processors and a memory coupled to the one or more processors, the memory storing instructions being executed by the one or more processors, the one or more processors configured to:
receive one or more alerts related to an event on the social media platform from a service provider;
subscribe the event on the social media platform;
send a response of the subscription to the service provider; and
receive access credentials for premises on a user application associated with the user based on the response.
